(19) United States
(12) Patent Application Publication
(10) Pub. No.: US 2024/0343651 A1
(43) Pub. Date: Oct. 17, 2024

(54) DAMAGE-RESISTANT ZIRCONIA SINTERED BODY WITH HIGH STRENGTH, HIGH TOUGHNESS AND ANTIBACTERIAL PROPERTIES

(71) Applicant: James R. Glidewell Dental Ceramics, Inc., Newport Beach, CA (US)

(72) Inventors: Jae Won Kim, Irvine, CA (US); Tung Van Vo, Garden Grove, CA (US)

(73) Assignee: James R. Glidewell Dental Ceramics, Inc., Newport Beach, CA (US)

(21) Appl. No.: 18/631,825

(22) Filed: Apr. 10, 2024

Related U.S. Application Data
(60) Provisional application No. 63/495,659, filed on Apr. 12, 2023.

(51) Int. Cl. C04B 35/488; A61C 5/77; A61C 13/20; C04B 35/632; C04B 35/638; C04B 35/645; C04B 41/00; C04B 41/45; C04B 41/46; C04B 41/48; C04B 41/50

(52) U.S. Cl. CPC C04B 35/488; A61C 5/77; A61C 13/206; C04B 35/632; C04B 35/638; C04B 35/6455; C04B 41/0072; C04B 41/4535; C04B 41/4578; C04B 41/46; C04B 41/4857; C04B 41/5012; A61C 2201/00; C04B 2235/3246; C04B 2235/6022; C04B 2235/6567

(57) ABSTRACT

A method that includes: (a) ceramic injection molding a granulated mixture of yttria-stabilized zirconia powder and a thermoplastic organic binder resulting in an injection molded ceramic body; (b) heat treating the injection molded ceramic body under conditions sufficient for removing the thermoplastic organic binder from the injection molded body; (c) applying a solution to the injection molded ceramic body, the solution comprising a tantalum-containing material, a niobium-containing material, or a mixture of a tantalum-containing material and a niobium-containing material and penetrating at least a portion of the injection molded ceramic body with the solution; (d) sintering the injection molded ceramic body; and (e) hot isostatically pressing the sintered injection molded ceramic body.

This application claims the benefit of U.S. Provisional Patent Appl. No. 63/495,659, filed Apr. 12, 2023, which is incorporated herein by reference in its entirety.

### BACKGROUND

Zirconia ceramics are increasingly being applied in biomedical applications due to their high strength, excellent biocompatibility and esthetics for dental restorations, implants, and artificial joints. Immediately after titanium implants were developed in the 1960s, research on alternative materials for implants began, and as a result, alumina single-crystal sapphire was first clinically applied in Japan in 1972. After that, alumina implants were introduced to the United States in the 1980s but caused about 30% or more of clinical failures due to low fracture toughness, and as a result, they were completely withdrawn from the market in the 1990s.

To solve the mechanical weakness of alumina, high fracture toughness zirconia was developed and applied in orthopedic applications. However, clinical fracture caused by low-temperature deterioration of zirconia occurred.

Research was conducted to solve this low-temperature deterioration phenomenon, and as a result, yttria-stabilized, magnesia-stabilized, or ceria-stabilized zirconia was developed to partially improve the low-temperature deterioration phenomenon. In particular, yttria-stabilized zirconia, which was introduced to the market for the first time in 1985, has been widely used in the dental restoration market since 2008.

Although titanium dental implants have a successful clinical history of more than half a century, they still cause patient complaints. Against this background, it has been reported that about 3% of patients have an allergic reaction to heavy metals such as Al and V that are dissociated from titanium alloys, and that dissociated heavy metals cause an inflammatory reaction in tissues, thereby causing bacterial growth.

Recently, in accordance with the high demands of patients for esthetic dental treatment, there is an increasing need to solve the problem that the gray of titanium metal is reflected back through the implant soft tissue in the case of thin gum shape in the anterior part. In addition, clinical evidence that titanium dental implants are related to the occurrence of mucositis and bone loss due to various chemical reactions in the oral cavity is continuously announced.

From 1990 to 2000, a high-strength zirconia-based material (yttria stabilized zirconia, alumina toughened zirconia: ATZ) having excellent aesthetics was developed and is widely used as zirconia dental implants today.

Since zirconia does not release heavy metal ions (unlike titanium implants), it is highly biocompatible and increases osteoblast adhesion and cell proliferation, which are responsible for rapid growth of the bone-implant interface. These properties contrast with titanium alloys, which impair cell viability and induce apoptosis, reducing osteoblasts and bone quality. In addition, it is known that zirconia has much less initial attachment and colonization of bacteria on its surface than titanium alloy, and due to this property, the surrounding soft tissue heals quickly. Despite these various advantages of zirconia ceramics, the inherent brittleness of zirconia ceramics can still cause complications such as fractures in biomedical devices, which can hinder clinical applications.

### SUMMARY

Disclosed herein is a method comprising:
(a) ceramic injection molding a granulated mixture of yttria-stabilized zirconia powder and a thermoplastic organic binder resulting in an injection molded ceramic body;
(b) heat treating the injection molded ceramic body under conditions sufficient for removing the thermoplastic organic binder from the injection molded body;
(c) applying a solution to the injection molded ceramic body, the solution comprising a tantalum-containing material, a niobium-containing material, or a mixture of a tantalum-containing material and a niobium-containing material and penetrating at least a portion of the injection molded ceramic body with the solution;
(d) sintering the injection molded ceramic body; and
(e) hot isostatically pressing the sintered injection molded ceramic body.

The foregoing will become more apparent from the following detailed description, which proceeds with reference to the accompanying figures.

### BRIEF DESCRIPTION OF THE DRAWINGS

FIGS. 1A-ID FIGS. 1A, 1B, 1C, and 1D are perspective views of dental restorations.

FIG. 2 is a cross-sectional illustration of a dental restoration.

FIG. 3. Ceramic injection process flow chart.

FIG. 4. Images showing cross-section surface damage behavior of zirconia dental implants by micro indentation. Vickers indentation conditions: Cross-section and well-polished zirconia implant surface were damaged for 15 seconds with a 20N indentation load: (a) 20ATZ Control, (b) 20ATZ test piece treated with a 10% tantalum-containing solution (also referred to herein as BruxZir Steel™ or “BS”) forming a functional gradient coating layer (FGCL).

FIG. 5 is a graph showing the effect of ammonium metatungstate (AMW) on antibacterial properties of zirconia dental implant materials. Bacterial species: (a) S. mutans (an aerobic bacterium); (b) P. gingivalis (an anaerobic bacterium). The material used to prepare the test samples was BruxZir® HT 2.0 (3YSZ) from Glidewell Laboratories. Test samples were treated with #220 SiC sand paper, then coated with ammonium metatungstic acid (AMW) coating solutions (0.025% and 0.3%) after treatment with the tantalum alkoxide coating solution. The control samples were not treated with ammonium metatungstic acid (AMW) or tantalum alkoxide. Total testing time was 24 hours.

FIG. 6 is a graph that shows the residual stress behavior that can occur in the zirconia microstructure with and without the tantalum alkoxide diffusion coating composition solution in the alumina-reinforced zirconia dental implant material. The thickness and distribution of the diffusion coating of the tantalum coating directly depend on the added polyvinylpyrrolidone (PVP) content. In particular, when the amount of PVP added increases, the tantalum coating can be predicted from the distribution of residual stress that a functional gradient coating layer is formed from the outer surface to the inner surface of zirconia. This residual stress (compressive stress) can contribute to suppression of crack initiation and crack propagation that can be formed from the outer surface of the implant and to improvement of flexural strength.

On the other hand, it can be predicted that the tantalum composition without PVP is uniformly diffused and distributed from the outer surface of the zirconia to the deep inner surface. In this case, the presence of compressive stress in the implant body is very insignificant, but the unique properties of the tantalum additive contribute to rapidly improving the fracture toughness of the zirconia dental implant. This can also play a role in suppressing crack initiation and crack propagation that can be formed from the outer surface of the implant due to the characteristics of zirconia with high fracture toughness. Monolith zirconia, such as 10ATZ control and 20ATZ control (Zeramax Implant), shows that no noticeable residual stress distribution can be observed.

FIG. 7 is a graph that shows the fracture toughness behavior that can occur in zirconia microstructures depending on the presence or absence of tantalum alkoxide diffusion coating composition solutions in alumina toughened zirconia dental implant materials.

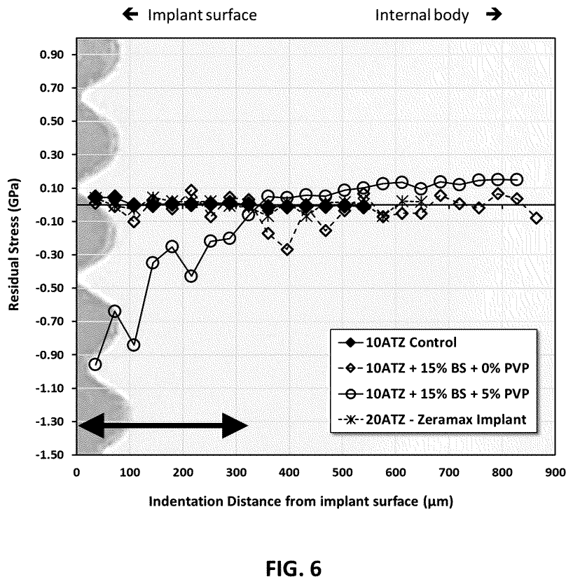

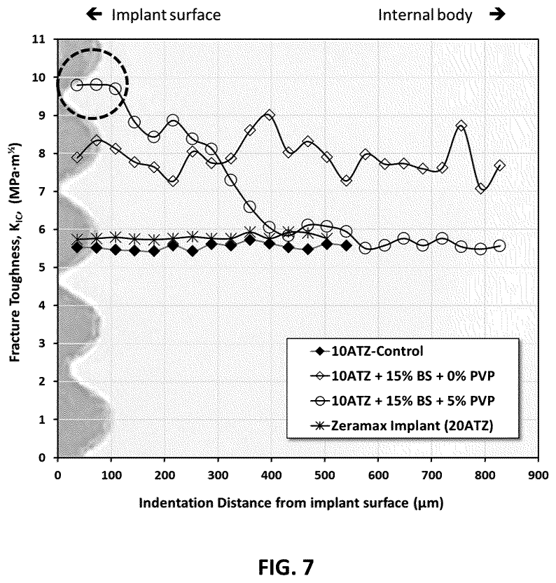

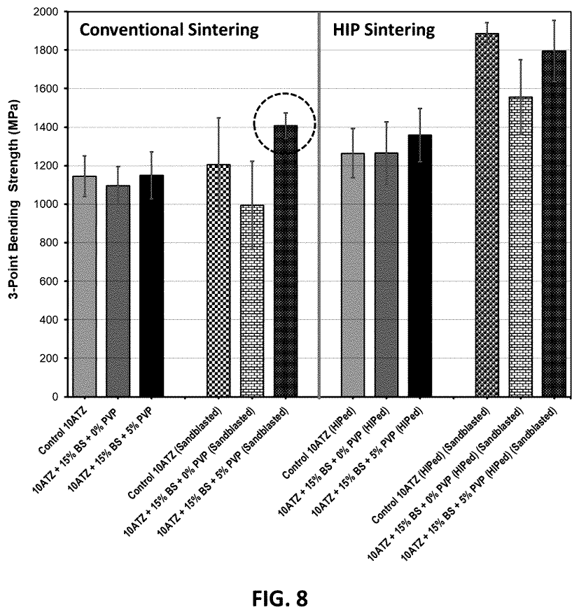

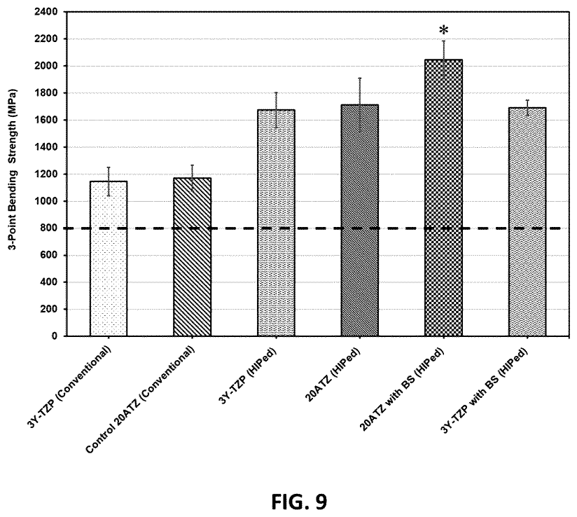

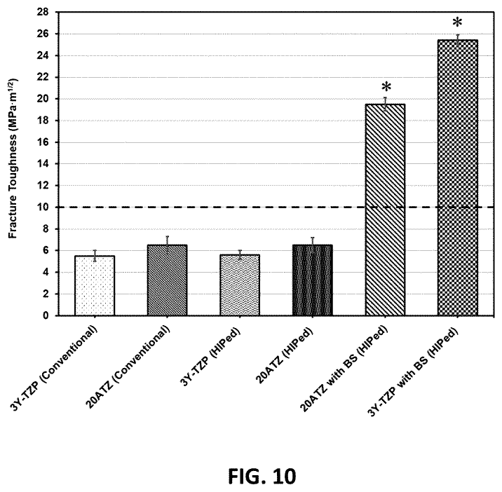

As mentioned in relation to FIG. 6, the thickness and distribution of the diffusion coating of the tantalum coating directly depend on the added PVP content. In particular, it can be predicted from the distribution of fracture toughness that a functional gradient coating layer is formed from the outer surface of the zirconia to the inner surface of the tantalum coating when the amount of PVP added increases. In particular, the distribution of tantalum additives in the zirconia structure directly affects the fracture toughness properties. As shown in FIG. 7, the diffusion coating of the tantalum solution to which 5% PVP is added forms a functional gradient microstructure from the outer surface of the zirconia to the inner surface. As a result of measuring the fracture toughness by the micro-indenter method, the fracture toughness near the outer surface is much higher than the value of the fracture toughness at the inner surface. The characteristics of high fracture toughness can fundamentally suppress the generation of microcracks that can be caused by external pressure or impact.

On the other hand, it can be predicted that the tantalum composition without PVP is uniformly diffused and distributed from the outer surface of the zirconia to the deep inner surface. For example, in the case of 10ATZ with 15% tantalum additive (BS), the tantalum additive is uniformly doped in the implant body, which can be easily predicted by looking at the fracture toughness distribution results. The fracture toughness values of monolithic zirconia, such as 10ATZ control and 20ATZ (Zeramax Implant) without tantalum additives (BS), show significantly lower fracture toughness properties than implants with tantalum additives. This is expected to negatively affect the fatigue life of zirconia dental implants.

FIG. 8 is a graph that shows the effect of diffusion coating treatment with a tantalum alkoxide composition and hot isostatic pressure (HIP) sintering on the mechanical properties of an alumina toughened zirconia (10ATZ-based) dental implant material. The hot isostatic pressure (HIP) sintering conditions of the zirconia dental implant material were sintered at a pressure of about 138 MPa and 1500° C. for about 2 hours in an argon gas atmosphere. All measured zirconia flexural strength test bars were blasted at 60 psi pressure with alumina sand with an average grain size of 50 microns prior to strength testing. Sandblasting treatment is used for the purpose of improving osseointegration by increasing the roughness of the surface of zirconia dental implants.

The following conclusions were made from testing and analyses of the test bars subjected to the processes described in the graph. First, HIPed specimens showed high flexural strength. Second, sandblasted specimens showed high flexural strength due to the phase transformation toughening mechanism. Third, specimens treated with BruxZir Steel+5% PVP showed a high increase in flexural strength. Fourth, specimens treated with BruxZir Steel+5% PVP showed a significant increase in flexural strength in HIP-treated specimens. Fifth, specimens treated with BruxZir Steel+5% PVP were HIP-treated and the specimens with sandblast showed the highest flexural strength. Sixth, all HIP-treated specimens exhibited gray color discoloration.

FIG. 9 is a graph showing the effects of applying a tantalum-containing solution (BS) and hot isostatic pressure (HIP) treatment on the flexural strength of zirconia (3Y-TZP and 20ATZ-based) dental implant materials. This graph shows the mechanical properties of various zirconia dental implant materials according to sintering and coating processes. A significant difference in flexural strength can be seen between the conventional zirconia (3Y-TZP and HIP treated 20ATZ) and the new version of zirconia (HIP and tantalum additive (BS) zirconia).

FIG. 10 is a graph showing the effects of tantalum-containing solution (BS) and hot isostatic pressure (HIP) treatment on the fracture toughness of zirconia (3Y-TZP and 20ATZ-based) dental implant materials. This graph shows a significant difference in fracture toughness properties between the conventional zirconia (3Y-TZP and HIP treated 20ATZ) and the new version of zirconia (HIP and tantalum additive (BS) treated zirconia).

### DETAILED DESCRIPTION

Disclosed herein are unique methods capable of increasing the durability of a zirconia dental implant by significantly improving the flexural strength, fracture toughness, and other properties compared to the physical properties of conventional zirconia dental implant materials. Unlike titanium dental implants, zirconia dental implants have excellent aesthetics and biocompatibility, as well as high mechanical strength and fracture toughness. Nevertheless, the inherent brittleness of zirconia ceramics may still cause complications such as fractures in biomedical devices, which may hinder clinical applications.

Although zirconia dental implants have various functional advantages that titanium dental implants do not have, the hardness of the material is very high, making it impossible to process with general dental tools and requiring milling with diamond tools. In addition, the processing period is very long when manufacturing dental implants with the conventional fully sintered zirconia material. A significant amount of expensive equipment must be secured for mass production.

The methods disclosed herein facilitate mass production of zirconia implants through a ceramic injection molding (CIM) process that can compensate for the difficulty of milling processes for zirconia dental implants or the problem of increased production cost. Also disclosed herein is a single or binary mixed solution for treating a porous zirconia-based implant material resulting in forming a functional gradient coating layer (FGCL) on the external surfaces and/or or internal porous structure of the zirconia implant. Consequently, the fracture toughness and flexural strength dramatically improves, which directly affect the durability of implants. Furthermore, the methods disclosed herein include hot isostatic pressing (HIP) sintering at a sufficiently high temperature for achieving the theoretical density of the zirconia dental implant sintered body.

The CIM process involves introducing zirconia granules into an injection molding machine. The granules are molded under high injection pressure by heating the molding machine barrel and the mold prior to introduction of the granules into the machine. For example, the molding machine barrel may be heated to 190° C. to 220° C., more particularly 200° C. to 210° C., and the mold may be heated to a temperature of 60° C. to 120° C., more particularly 100° C. to 120° C. The granules are heat molded under pressure. The molding pressure may be 120 bar to 300 bar, more particularly 200 bar to 300 bar. The molding temperature is the same as above.

The zirconia granules are a granulated mixture of zirconia powder and a thermoplastic organic binder. The thermoplastic organic mixture may use polyvinyl butyral (PVB) as a structural polymer, polyethylene glycol (PEG) as a basic polymer of the binder system, and stearic acid as a dispersant to achieve steric stabilization of the zirconia powder particles.

In certain embodiments, the granules contain at least about 45%, or at least about 55%, or at least about 65%, by weight of the thermoplastic organic binder. Examples of the zirconia granules for ceramic injection molding include PXA-233P (3YSZ), PXA-303P (3YS10A), and 3PXA-304 (3YS20A), all commercially available from Tosoh. PXA-304 (3YS20A) is 20% alumina toughened zirconia, and PXA-303 (3YS10A) is 10% alumina toughened zirconia.

The zirconia may comprise zirconia ceramic material such as (unstabilized) zirconia or stabilized zirconia, where stabilized zirconia includes partially stabilized or fully stabilized zirconia. Examples of stabilized zirconia suitable for use herein include commercially available ceramic materials from Tosoh USA, such as zirconia that has been stabilized with yttria, (e.g., YSZ zirconia from Tosoh) including approximately 0.1 mol % to approximately 8 mol % yttria, or approximately 1 mol % yttria to approximately 3 mol % yttria or approximately 2 mol % yttria to approximately 7 mol % yttria, or approximately 2 mol % yttria to approximately 6 mol % yttria, or approximately 2 mol % yttria to approximately 5 mol % yttria, or approximately 3 mol % yttria to approximately 5 mol % yttria, or approximately 3 mol % yttria to approximately 4 mol % yttria, or approximately 4 mol % yttria to approximately 5 mol % yttria, or approximately 3.5 mol % yttria to approximately 5 mol % yttria.

Zirconia materials may comprise approximately 85 wt % to approximately 100 wt % zirconia or stabilized zirconia, based on the total weight of the zirconia ceramic material, or approximately 85 wt % or greater, or approximately 90 wt % or greater, or approximately 95 wt % or greater, or more than approximately 97 wt % or greater zirconia or stabilized zirconia, based on the total weight of the zirconia ceramic material. Other materials, such as, alumina may also be included in the zirconia ceramic material. Zirconia ceramic bodies may be formed from zirconia powder having a substantially uniform particle size distribution, such as powder with an average size in a range from approximately 0.005 micron (μm) to approximately 1 μm. Examples of ceramic material suitable for use herein also include zirconia described in commonly owned U.S. Pat. Nos. 8,298,329, 10,532,008, and 10,479,729, each of which is hereby incorporated herein by reference in its entirety.

The zirconia granules may be molded into a shape such as a block, disk, near net shape, or a form that approximates the size and/or shape of a single or multi-unit dental restoration, such as a crown, on-lay, bridge including a multi-unit bridge comprising restorations having more than one tooth structure, a partial or full solid-body denture, or a supporting structure such as an implant or an abutment.

After the CIM process, the resulting injection molded body is removed from the CIM machine and subjected to bisquing for removing the organic binder that is present in the zirconia granular starting material. In certain embodiments, the injection molded body is subjected to heating at a temperature of at least 450° C., more particularly at 1050° C. in ambient atmosphere. In certain embodiments, the injection molded body is subjected to heating at a temperature of 450° C. to 1000° C., more particularly at 450° C. to 950° C. in ambient atmosphere for 100 to 130 hours, more particularly 109 to 116 hours. The organic binder is volatilized during the removal step.

The bisqued intermediate body is subsequently treated with a single or binary mixed solution resulting in forming a functional gradient coating layer (FCCL) on the external surfaces and/or or internal porous structure of the bisqued zirconia intermediate. The single or binary mixed solution includes a tantalum-containing material, a niobium-containing material, or both a tantalum-containing material and a niobium-containing material.

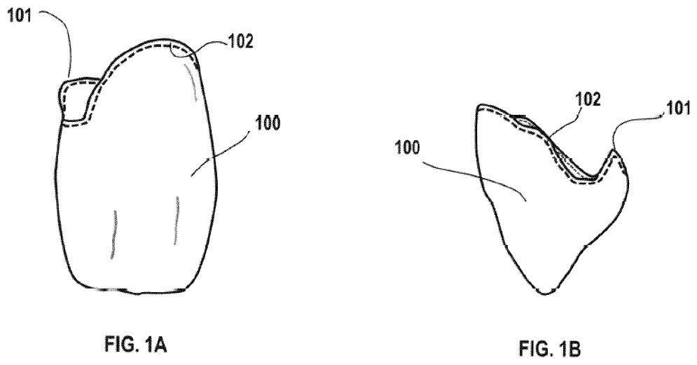

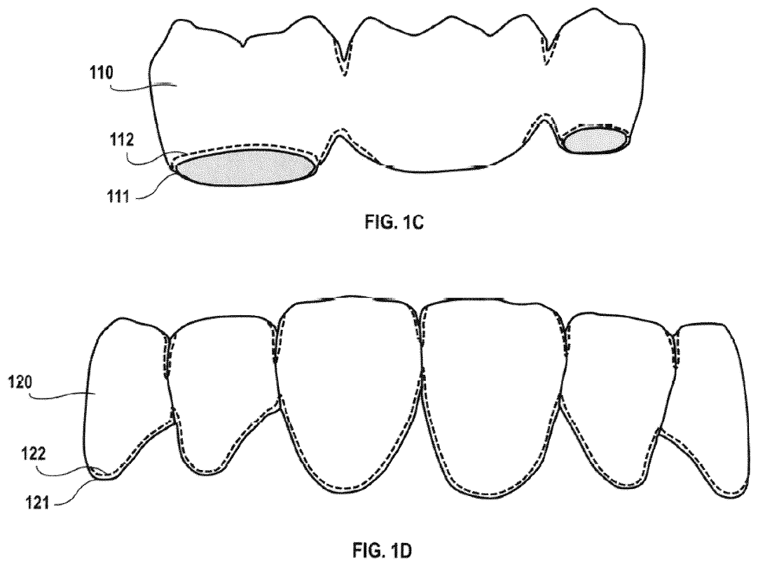

For example, in one embodiment, with reference to FIGS. 1A and 1B, a bisque stage intermediate body (e.g., a ceramic crown) 100 is treated by brush coating a liquid tantalum-containing composition on the margin 101 where the thickness of the ceramic material tapers to the edge. The tantalum-containing composition may be applied to a surrounding margin region 102 for a distance sufficient to provide a region having increased flexural strength and fracture toughness without significantly decreasing the optical properties of the material. In another embodiment, with reference to FIG. 1C, a bisque stage intermediate body (e.g., a three-unit bridge 110 is treated by brush coating a liquid tantalum-containing composition on the margin 111 where the thickness of the ceramic material tapers to the edge. The tantalum-containing composition may be applied to a surrounding margin region 112 for a distance sufficient to provide a region having increased flexural strength and fracture toughness without significantly decreasing the optical properties of the material. In still another embodiment, with reference to FIG. 1D, a plurality of bisque stage intermediate bodies (e.g., veneers) 120 are treated by brush coating a liquid tantalum-containing composition on the margins 121 where the thickness of the ceramic material tapers to the edge. The tantalum-containing composition may be applied to a surrounding margin region 122 for a distance sufficient to provide a region having increased flexural strength and fracture toughness without significantly decreasing the optical properties of the material.

Liquid tantalum (and/or niobium) containing compositions comprise an amount of tantalum (and/or niobium) in a sufficient amount to achieve a selected enhancement of mechanical properties in a sintered ceramic body. A liquid component may be selected in which the desired amount of tantalum (and/or niobium) containing material remains in solution. The liquid may comprise water, or an organic solvent such as, methanol, ethanol, isopropanol, butanol, pentanol, butyraldehyde, acetone, or combinations thereof. In some embodiments, the solvent is less than 99% pure. In other embodiments, a solvent having an impurity or water content that is less than 4 wt % (e.g., anhydrous ethanol), two or more solvents may be used in combination. In one embodiment, a liquid tantalum-containing composition comprises a mixture of methanol and isopropanol. In another embodiment, a liquid tantalum-containing composition comprises a mixture of butyraldehyde and acetone.

The tantalum (and/or niobium) containing material may comprise an oxide or salt containing tantalum (and/or niobium), such as, tantalum (or niobium) chloride or tantalum (or niobium) alkoxide. The amount of tantalum-containing material (or niobium-containing material) in a tantalum-containing composition (or niobium-containing composition) may range from approximately 10 wt % to approximately 70 wt % of the tantalum-containing composition (or niobium-containing composition). In some embodiments, a tantalum-containing composition comprises from 10 wt. % to 40 wt. % of the tantalum-containing material, based on the total weight of the tantalum-containing composition, or from 40 wt. % to 70 wt. %, or from 45 wt. % to 70 wt. %, or from 45 wt. % to 65 wt. %, or from 50 wt. % to 70 wt. %, or from 55 wt. % to 65 wt. %, of the tantalum-containing material, based on the total weight of the tantalum-containing composition. Examples of tantalum-containing materials include, but are not limited to, tantalum chloride (e.g., tantalum (V) chloride anhydrous), and tantalum alkoxide (e.g., tantalum (V) methoxide, tantalum (V) isopropoxide or tantalum (V) ethoxide). As noted above, the tantalum-containing solutions and/or niobium-containing solutions are also referred to herein as BruxZir Steel™ (or “BS”) solutions.

In certain embodiments, metal ions such as Zn, Mo, or W can be added to the tantalum and/or niobium-containing composition. Metal ions can be prepared from the form of salts, e.g., zinc chloride, or zinc sulfate, or ammonium meta tungstate, or ammonium paramolybdate. In certain embodiments, the composition may include 0.025 to 5 wt. %, or 0.05 to 5 wt. %, of a metal ion such as Zn, Mo, or W, based on the total weight of the composition.

In one specific embodiment, a tantalum-containing solution comprises 5 wt % to 50 wt % tantalum ethoxide and 1 wt % to 10 wt % polyvinylpyrrolidone (PVP).

In one specific embodiment, a tantalum-containing solution comprises 10 wt % to 40 wt % of tantalum chloride hexahydrate and from 60 wt % to 90 wt % isopropanol.

In another embodiment, a tantalum-containing solution comprises from 10 wt % to 60 wt % tantalum ethoxide and 35 wt % to 90 wt % isopropanol, and 0 wt % to 5 wt % of an organic additive, e.g., polyvinylpyrrolidone (PVP).

In a further embodiment, a tantalum-containing solution comprises from 10 wt % to 60 wt % tantalum ethoxide and 35 wt % to 89 wt % isopropanol, 1 wt % to 10 wt % methanol, and 0 wt % to 5 wt % of polyvinylpyrrolidone (PVP).

In a further embodiment, a tantalum-containing solution comprises from 30 wt % to 60 wt % tantalum ethoxide and 40 wt % to 70 wt % ethanol. In a further embodiment, an equivalent amount of ethanol (by weight percent) may be replaced with 1 wt % to 10 wt %, or from 1 wt % to 5 wt %, of polyvinylpyrrolidone (PVP).

In another embodiment, a tantalum-containing solution comprises from 30 wt % to 60 wt % tantalum ethoxide and 40 wt % to 70 wt % acetone and butyraldehyde mixture.

A color marker may be added to the tantalum (or niobium) containing composition, such as an organic colorant that burns off upon sintering, such as rhodamine B. Rhodamine B may be present in an amount sufficient to facilitate application of the composition to the ceramic body.

A wetting agent may be added to control the depth of penetration of the tantalum (or niobium) containing composition into the porous ceramic body. Wetting agents include, but are not limited to polymers that are soluble in the solvent system of the composition.

In one embodiment, a tantalum-containing composition comprises 10 wt % to 70 wt % tantalum-containing material, 35 wt % to 90 wt % of a solvent comprising methanol, ethanol, isopropanol or a combination thereof, wherein the solvent comprises less than 3 wt % water, and optionally, a polymer. In some embodiments, where the solvent comprises less than 49 wt % anhydrous IPA and less than 40 wt % anhydrous ethanol, the tantalum-containing composition is stable for at least 6 months at ambient conditions.

A coloring agent may also be added to the tantalum (or niobium) containing composition in an amount to achieve a specific lightness, hue and/or chroma value in the final sintered ceramic body. One or more metallic compounds or metallic complexes may be selected to impart a shade suitable for use in dental restorations, such as a shade based on an industry-recognized shade guide, such as the VITA Classical® Shade Guide. Metallic compounds and metallic complexes may contain transition metals from groups 3 through 14 on the periodic table, rare earth metals, and mixtures thereof. Metal-containing components in the form of metal oxides, alkoxides or metal salts may contain anions, including but not limited to, OH⁻, Cl⁻, SO₄²⁻, SO₃²⁻, Br⁻, F⁻, NO₂⁻, and NO₃⁻.

In some embodiments, coloring agents may comprise oxides or salts of iron, terbium, erbium, chromium, cobalt and manganese. In one embodiment, coloring agents comprise at least one metallic salt of chromium, terbium, and manganese in the forms of terbium chloride, chromium chloride, and manganese sulfate, respectively. The amount of coloring agent in a yttrium-containing composition may be approximately 0.05 wt % to approximately 2 wt %, or approximately 0.1 wt % to approximately 0.5 wt %, or approximately 0.07 wt % to approximately 1 wt %, based on the total weight of the yttrium-containing composition. Coloring liquids to be incorporated into yttrium-containing compositions may be prepared as aqueous coloring solutions having no solid colorant particles that are detectable at ambient temperature to the unaided eye after mixing a coloring agent with a solvent. Coloring agents suitable for use herein may include coloring liquids, described in commonly owned U.S. Pat. Nos. 9,512,317, 9,365,459 and 9,095,403, each of which is hereby incorporated herein by reference in its entirety.

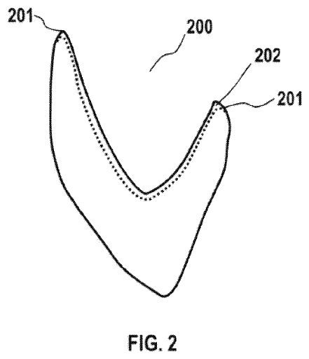

Application techniques for applying the tantalum (and/or niobium) containing composition to penetrate the porous, pre-sintered ceramic bodies include, but are not limited to, painting, dipping, spraying, or infiltrating the ceramic body with the tantalum (and/or niobium) containing composition by other known application methods. The tantalum (and/or niobium) containing composition may be applied to penetrate regions of ceramic dental components that are susceptible to cracking or chipping. For example, in one embodiment, as illustrated in the cross-sectional view of a dental crown 200 of FIG. 2, the tantalum (and/or niobium) containing composition may penetrate the edge or a region of the crown, or the margin 201 that abuts the patient's gingiva. For example, where the tantalum (or niobium) containing composition is brushed or otherwise applied adjacent the margin edge 201, in the sintered body tantalum (or niobium) may penetrate to a depth 202 of approximately 0.5 mm to approximately 3 mm, or approximately 0.5 mm to approximately 4 mm, or approximately 0.5 mm to approximately 5 mm, or approximately 1 mm to approximately 5 mm.

Accordingly, in some embodiments, a gradient of tantalum (and/or niobium) concentration is provided within the ceramic dental component with a higher tantalum (and/or niobium) concentration nearer to the surface and a lower tantalum (and/or niobium) concentration at an internal distance away from the surface. The tantalum (and/or niobium) concentration gradient provides a gradient of the physical properties (e.g., flexural strength, fracture toughness) within the body of the ceramic (e.g., zirconia) dental component. For example, in some embodiments, a sintered zirconia body having an yttria concentration of from 4-6 mol % that has been treated with a tantalum (and/or niobium) containing composition in the manner described herein may have a surface region with a fracture toughness that is greater than 4.0 MPa·m^{1/2}, such as greater than 5.0 MPa·m^{1/2}, such as greater than 6.0 MPa·m^{1/2}, or greater than 7.0 MPa·m^{1/2}, while having a fracture toughness at an interior region spaced internally from the surface region that is lower than the surface region fracture toughness and that is less than 4.0 MPa·m^{1/2}, such as less than 3.0 MPa·m^{1/2}, or less than 2.5 MPa·m^{1/2}. In some embodiments, the surface region may occupy a depth of less than 1.0 mm from the outer surface of the zirconia body, such as a depth of less than 500 μm from the outer surface of the zirconia body, such as a depth of less than 250 μm from the outer surface of the zirconia body, such as a depth of less than 150 μm from the outer surface of the zirconia body, or a depth of less than 100 μm from the outer surface of the zirconia body.

In another embodiment, the tantalum (and/or niobium) containing composition may be applied to a region adjacent the attachment means of an implant supported denture. For example, the tantalum (and/or niobium) containing composition may be applied around a through hole of a screw retained denture. In other embodiments, where the dental restoration component comprises an implant or abutment, the entire ceramic body may be coated, for example by dipping in the tantalum (and/or niobium) containing composition to provide enhanced mechanical properties throughout the component.

In another embodiment, a porous single unit block, pre-form or near net shape may be dipped in a tantalum (and/or niobium) containing composition to achieve partial or complete penetration through the thickness of a body. In another embodiment, the tantalum (and/or niobium) containing composition may be applied to one or more sides or surfaces of a block, pre-form or near net shape, for partial penetration through the surface.

The porous ceramic bodies may be sintered after treatment with the tantalum (and/or niobium) containing composition (referred to herein as “primary sintering”). For example, the treated ceramic body may be subjected to heating at a temperature of at least 1450° C., more particularly at 1550° C. in ambient atmosphere. In certain embodiments, the treated ceramic body is subjected to heating at a temperature of 1450° C. to 1500° C., more particularly at 1480° C. to 1520° C. in an ambient atmosphere for 1.5 to 3.5 hours, more particularly 2 to 3 hours.

After the primary sintering, HIP (Hot Isostatic Pressing) treatment is performed on the ceramic body. The HIP treatment substantially completely removes defects that may exist in the zirconia dental implant body to achieve the theoretical density of the zirconia sintered body. More specifically, the HIP process is a manufacturing method using gas (e.g., Ar) as a pressure transmission medium, and when pressure is applied to a primary sintered material, the material undergoes three-dimensional equivalent deformation. At this time, it is possible to produce a defect-free final product reaching the theoretical density by applying heat and pressure to the primary sintered material at the same time.

In certain embodiments, the HIP is at a temperature of at least about 1400° C. In certain embodiments, the FGCL-treated zirconia primary sintered body is HIP sintered for about 1 to 5 hours, or 2 to 3 hours, at a temperature of 1450° C. to 1600° C., or 1450° C. to 1550° C. in an Ar gas atmosphere and a pressure of 137 to 206 MPa, or 137 to 172 MPa.

Optionally, a sandblasting treatment may be applied to a portion of the ceramic body treated that has been with the tantalum (or niobium) containing composition. Regions of a ceramic body treated with a tantalum (or niobium) containing composition and a sandblasting treatment demonstrate further enhancements of flexural strength, fracture toughness or both.

After sintering and HIP-treating to approximately full theoretical density, treated, sintered ceramic bodies have enhanced mechanical properties without a reduction in translucency when compared to an untreated, sintered ceramic body comprising a substantially similar yttria-stabilized zirconia ceramic material.

Hot isostatically pressed sintered zirconia ceramic bodies according to the methods described herein, have a 3-point flexural strength of at least 1800 MPa, or at least 2400 MPa, when measured according to the methods described herein. Sandblast treatment was performed under a pressure of 60 psi with alumina sand of 50-micron particles for all zirconia dental implant materials for measuring flexural strength. This case is one of the surface treatments considering the worst-case scenario of the material. The high surface roughness of zirconia dental implants is advantageous for osteointegration. It is known that the ideal surface roughness for osteoblast cells to deposit on the implant surface is approximately Sr=0.8-1.2 microns. The presence or absence of tantalum-containing solution (BS) and hot isostatic pressure (HIP) treatment has a great effect on the flexural strength of the zirconia dental implant.

Hot isostatically pressed sintered zirconia ceramic bodies according to the methods described herein, have a fracture toughness of at least 13 MPa·m^{1/2}, or at least 26 MPa·m^{1/2}, when measured according to the methods described herein. It can be seen that the diffusion coating treatment of the tantalum-containing solution (BS) on the injection-molded and fired zirconia body in the present invention has a great effect on the fracture toughness of dental zirconia implants. According to the literature, it is known that a material with a fracture toughness value of 10 MPam^{1/2} or more has a ductile behavior similar to that of a metal alloy. On the other hand, conventional zirconia (3Y-TZP, 10ATZ, 20ATZ) shows fracture toughness of 5-7 MPam^{1/2}, so brittleness can still be expected. Actually, high fracture toughness value is one of the most important physical properties for extending the fatigue life of zirconia dental implant. Therefore, the methods disclosed herein can have a great positive effect on improving the fatigue life of the zirconia dental implant due to its extremely high fracture toughness.

The FGCL is a damage resistant protective layer that can be created in a zirconia body such that the location and geometry of the protective layer can be controlled. The provision of a protective layer provides a capability of simultaneously manipulating mechanical properties such as fracture toughness and flexural strength by forming a tantalum or niobium-based selective diffusion protective coating layer on the outer surface and inside of the zirconia body. The depth of the FGCL has characteristics that can be adjusted depending on the concentration of tantalum or niobium alkoxide and the concentration of added organic additives (e.g., polyvinyl pyrrolidone (PVP)). Damage resistant FGCL diffuses toward the outer surface or into the bulk of zirconia to help mitigate crack propagation in the contact area of the sintered body.

Fractures in dental restorations are often caused by material failures. To reduce the fracture rate of dental restorations, it is important to understand the mechanism by which zirconia fractures. There are three classes of failure modes for single crowns, multi-unit bridges and full arches. The first of such are cracks (cone, median) or chips that occur at the occlusal surface of restorations. These type of failures are rare in full strength zirconia (3Y-TZP) devices. The second failure mode is via radial fracture which is often caused by tensile stresses at the cementation surface. This type of fracture is the primary mode of failure, and is responsible for more than 95% of failures in zirconia restorations. The third failure mode is due to operator error; though uncommon; and involve cracks on the anterior mandibular surface due to hand milling using diamond tools by dental technicians. In order to reduce fracture cases occurring in zirconia ceramic restorations, it is useful to mitigate cracking in their most vulnerable regions. For this, the brittleness of these regions may be reduced, fracture toughness and mechanical strength of the protected areas are increased, and fracture rates are thereby reduced.

Accordingly, in some embodiments, crack propagation is reduced or prevented by forming a FGCL with high fracture toughness in the microstructure inside a zirconia body. To achieve this, a tantalum (or niobium) containing composition is applied to a porous bisque-fired zirconia prosthesis formed by CAD/CAM machining of a dental zirconia milling blank. Zirconia that can be treated by the tantalum (or niobium) containing composition may have yttria concentrations ranging between 3Y-TZP to 12Y-PSZ. In order to form an FGCL within a zirconia body, a precursor containing tantalum alkoxide (or niobium alkoxide) is infiltrated into the bisque-fired porous zirconia body by dipping or painting before being sintered to maximal or near maximal density. By controlling the depth, thickness, location, and other size or geometric features of the FGCL, it is possible to suppress crack propagation into the bulk microstructure of the zirconia even if damage is formed on the surface of the zirconia sintered body. It is further possible to improve the lifespan of the restoration by suppressing cracks and improving the mechanical strength.

In addition, the presently disclosed methods can significantly improve the fatigue life of the implant by suppressing crack formation and transition that may occur on the surface of a conventional zirconia dental implant that is vulnerable to brittleness. The presently disclosed methods also reduce manufacturing costs by using a ceramic injection process capable of mass production compared to the existing dental implant manufacturing process (mechanical milling process).

By forming and sintering the gradient coating layer, long-term antibacterial effect and damage resistance are simultaneously achieved. The manufacturing processes disclosed herein also can enable easily adjusting the depth of a functional ceramic gradient coating layer according to the concentration of an organic binder for coating added to Ta or Nb alkoxide single or binary mixture solution.

### EXAMPLES

Table 1 shows several examples having differing values for ceramic injection molding process variables. A zirconia granular material containing a thermoplastic resin binder is injected into an injection molding machine and molded. In the examples of Table 1, the ceramic injection process is a method of molding by injecting a commercially available ceramic granular material into an injection molding machine, adjusting the temperature of the barrel to about 120° C. to 220° C., and preferably having a mold temperature of 60° C. to 130° C. The molding can occur in an injection pressure range of about 100 bar to 300 bar by heating.

TABLE 1
Table 1. Mechanical parameters of injection machine for ceramic injection molding

| TEST SAMPLES | 0 | 1 | 2 | 3 | 4 | 5 | 6 | 7 | 8 | 9 | 10 |
|---|---|---|---|---|---|---|---|---|---|---|---|
| BARREL TEMP (° C.) | 195 | 210 | 210 | 210 | 210 | 210 | 210 | 210 | 210 | 210 | 210 |
| MOLD TEMP (° C.) | 60 | 100 | 100 | 100 | 110 | 110 | 120 | 100 | 100 | 120 | 120 |
| MIN BARREL TEMP (° C.) | 180 | 190 | 190 | 190 | 190 | 190 | 190 | 190 | 190 | 190 | 190 |
| INJECT PRESSURE (BAR) | 300 | 180 | 120 | 300 | 300 | 300 | 300 | 120 | 300 | 120 | 300 |
| HOLD PRESSURE (BAR) | 250 | 250 | 250 | 250 | 250 | 250 | 250 | 250 | 250 | 250 | 250 |
| CLAMP FORCE (Kg) | 2500 | 2500 | 2500 | 2500 | 3000 | 3000 | 3000 | 2500 | 3000 | 2500 | 3000 |
| HOLDING TIME (mSEC) | 25000 | 25000 | 25000 | 25000 | 25000 | 25000 | 25000 | 25000 | 25000 | 25000 | 25000 |
| COOLING TIME (mSEC) | 15000 | 15000 | 15000 | 15000 | 15000 | 20000 | 20000 | 25000 | 25000 | 25000 | 25000 |
| CLAMP TIME (mSEC) | 11200 | 11200 | 11200 | 11200 | 11200 | 11200 | 11200 | 11200 | 11200 | 11200 | 11200 |
| CUT OFF AMOUNT (cu-cm) | 10 | 10 | 10 | 10 | 10 | 10 | 10 | 10 | 10 | 10 | 10 |
| FIRST STAGE (cu-cm) | 4 | 4 | 4 | 4 | 4 | 4 | 4 | 5 | 5 | 5 | 5 |
| VALVE FIRST POSITION | 180 | 180 | 180 | 180 | 180 | 180 | 180 | 180 | 180 | 180 | 180 |
| VALVE SECORND POSITION | 200 | 200 | 200 | 200 | 200 | 200 | 200 | 200 | 200 | 200 | 200 |
| HOPPER MULTIPLIER | 140 | 140 | 140 | 140 | 140 | 140 | 140 | 140 | 140 | 140 | 140 |
| HOPPER SPEED (1-20) | 10 | 10 | 10 | 10 | 10 | 10 | 10 | 10 | 10 | 10 | 10 |

In one embodiment, the organic binder removal and bisque firing process of the injection molded body involves slowly raising the temperature from room temperature to 970° C., thereby gradually and completely removing the organic binder. The entire organic binder removal and bisque firing process is performed for about 25 to 45 hours. An example of the binder removal and firing process of the injection body is heating from room temperature to 150° C. for about 1 hour, hold for about 30 to 60 minutes, and slowly heat from 150° C. to 400° C. for about 25 hours. The body is then heated from 400° C. to 450° C. for 1 hour, maintaining it for 2 to 3 hours, then gradually raising the temperature to 970° C., maintaining it for 1 to 3 hours, and then cooling it to room temperature.

One example of implementing the FGCL process is to include 5 to 30 wt. % of tantalum alkoxide or niobium alkoxide and about 0.05 to 5 wt. % of metal ions such as Zn, Mo, and W. After dipping, painting, or spray-coating these single- or binary-system mixed solutions on the calcined zirconia body (i.e., 3YSZ, 10ATZ, or Mung 20ATZ), primary sintering is performed at a temperature of about 1400° C. or higher.

Finally, the HIPed zirconia implant is blasted with 50 to 150 micron fused alumina sand particles under pressure of 50 to 100 psi. The fracture toughness (>10-26 MPa·m^{1/2}) of the zirconia HIP sintered body is rapidly increased by the transformation toughening (C→T→m) mechanism, and at the same time, the flexural strength (≥1800 MPa) is also rapidly increased due to the FGCL coating.

This result shows significantly improved mechanical properties compared to the values of flexural strength (≥1000-1200 MPa) and fracture toughness (5-7 MPa m %) of conventional sintered zirconia sintered bodies.

Table 2 shows the results of mechanical properties (flexural strength) according to the sintering method of 3YSZ-based zirconia dental implants. As shown in Table 2, the flexural strength of the HIP-treated zirconia dental implant is improved by about 66% compared to the flexural strength (1010 MPa) of the zirconia dental implant manufactured by the conventional sintering method. This indirectly indicates that defect-free zirconia dental implants reaching theoretical density can be manufactured by the HIP process regardless of BS (tantalum alkoxide solution) treatment.

TABLE 2

| | | 3-Point |
|---|---|---|
| | | Flexural |
| Group Name | Test Example | Strength (MPa) |
| 3Y | 3YSZ (1580° C. 2.5 hr | 1010 (±44) |
| | Conventional sintering) | |
| 3Y | 3YSZ (HIP, 20k PSI in Argon after | 1675 (±230) |
| | 1500° C. 2 hr sintering) | |
| 3Y10B5P | 3YSZ + 10% BS + 5% PVP (HIP, | 1690 (±56) |
| | 20k PSI in Argon after 1500° C. | |
| | 2 hr sintering) | |
| 3Y15B5P | 3YSZ + 15% BS + 5% PVP (HIP, | 1684 (±126) |
| | 20k PSI in Argon after 1500° C. | |
| | 2 hr sintering) | |

NOTE:
All flexural strength specimens were tested after sandblasting under 60 PSI pressure with 50-micron alumina particles after HIP treatment.

According to one embodiment, the change in flexural strength values of 10% alumina-reinforced zirconia (ATZ) dental implants obtained when the concentration of the BS (Tantalum Alkoxide Solution) coating solution is varied is shown in Table 3. As shown in Table 3, the flexural strength of the 10ATZ zirconia dental implant treated with HIP after coating with 10% (tantalum alkoxide solution) was about 13% higher than that of zirconia coated with 15% (tantalum alkoxide solution) BS.

TABLE 3

| | | 3-Point |
|---|---|---|
| | | Flexural |
| Group Name | Test Example | Strength (MPa) |
| 10A10B5P | 10ATZ + 10% BS + 5% PVP (HIP, | 1928 (±294) |
| | 20k PSI in Argon after 1500° C. | |
| | 2 hr sintering) | |
| 10A15B5P | 10ATZ + 15% BS + 5% PVP (HIP, | 1670 (±195) |
| | 20k PSI in Argon after 1500° C. | |
| | 2 hr sintering) | |

NOTE:
All flexural strength specimens were tested after sandblasting under 60 PSI pressure with 50-micron alumina particles after HIP treatment.

According to one embodiment, Table 4 shows the change in flexural strength of 10ATZ-based zirconia dental implants according to the presence or absence of BS (tantalum alkoxide solution) FGCL coating treatment and the sintering method. As shown in Table 4, the flexural strength of the 10ATZ-based zirconia dental implant prepared by the conventional sintering method showed similar flexural strength values regardless of the presence or absence of the BS (tantalum alkoxide solution) coating treatment. When zirconia implants coated with FGCL only with BS solution containing PVP binder were sintered at 1580° C., the flexural strength slightly decreased. However, when comparing the overall flexural strength results, it can be seen that the FGCL coating treatment of BS has little negative effect on the flexural strength of zirconia implants.

TABLE 4

| | | 3-Point |
|---|---|---|
| | | Flexural |
| Group Name | Test Example | Strength (MPa) |
| 10A | 10ATZ (1500° C. 2 hrs, | 1145 (±105) |
| | conventional sintering) | |
| 10A15B | 10ATZ + 15% BS (1500° C. 2 | 1097 (±97) |
| | hrs, conventional sintering) | |
| 10A15B5P | 10ATZ + 15% BS + 5% PVP | 1150 (±123) |
| | (1500° C. 2 hrs, conventional | |
| | sintering) | |
| 10A15B | 10ATZ + 15% BS (1580° C. 2.5 | 1021 (±53) |
| | hrs, conventional sintering) | |
| 10A15B5P | 10ATZ + 15% BS + 5% PVP | 980 (±62) |
| | (1580° C. 2.5 hrs, conventional | |
| | sintering) | |

Note:
All flexural strength specimens were tested after full sintering and without sandblasting treatment.

According to one embodiment, Table 5 shows the mechanical properties (flexural strength) of the 20ATZ-based zirconia dental implant according to the conventional sintering method and the presence or absence of the FGCL coating of BS (tantalum alkoxide solution) after the zirconia dental implant binder removal and firing process. As shown in Table 5, the flexural strength of the 20ATZ-based zirconia dental implant prepared by the conventional sintering method shows similar flexural strength values regardless of the treatment with or without BS (tantalum alkoxide solution).

TABLE 5

| | | 3-Point |
|---|---|---|
| | | Flexural |
| Group Name | Test Example | Strength (MPa) |
| 20A | 20ATZ (1500° C. 2 hrs, | 1170 (±95) |
| | conventional sintering) | |
| 20A15B5P | 20ATZ + 15% BS + 5% PVP | 1060 (±172) |
| | (1500° C. 2 hrs, conventional sintering) | |

Note:
All flexural strength specimens were tested after full sintering and without sandblasting treatment.

According to one embodiment, Table 6 shows the change in flexural strength of 20ATZ dental implants with and without BS FGCL coating and HIP sintering conditions after zirconia dental implant binder removal and firing process. As shown in Table 6, the flexural strength of 20ATZ dental implants manufactured under various HIP sintering conditions shows improved flexural strength values of at least 75% compared to zirconia dental implants manufactured by conventional sintering, as shown in Table 5.

TABLE 6

| | | 3-Point |
|---|---|---|
| | | Flexural |
| Group Name | Test Example | Strength (MPa) |
| 20A | 20ATZ (HIP, 20k PSI in Argon | 1889 (±90) |
| | after 1500° C. 2 hr sintering) | |
| 20A | 20ATZ (HIP, 30k PSI in Argon | 1913 (±88) |
| | after 1450° C. 2 hr sintering) | |
| 20A10B5P | 20ATZ + 10% BS + 5% PVP | 2032 (±72) |
| | (HIP, 20k PSI in Argon after | |
| | 1500° C. 2 hr sintering) | |
| 20A10B5P | 20ATZ + 10% BS + 5% PVP | 1986 (±165) |
| | (HIP, 30k PSI in Argon after | |
| | 1450° C. 2 hr sintering) | |

NOTE:
All flexural strength specimens were tested after sandblasting under 60 PSI pressure with 50-micron alumina particles after fully sintering.

Table 7 shows the change in 3-point flexural strength of 20ATZ dental implants according to various amounts of AMW (ammonium meta tungstate) mixed in BS (tantalum alkoxide solution) solution for FGCL coating after zirconia dental implant binder removal and firing process. As a result, as the concentration of AMW added to the BS solution increases, the flexural strength of the zirconia dental implant shows a slight decrease.

TABLE 7

| | | 3-Point |
|---|---|---|
| | | Flexural |
| Group Name | Test Example | Strength (MPa) |
| 20A10B0.025W5P | 20ATZ + 10% BS + 0.025% | 2046 (±377) |
| | AMW + 5% PVP (HIP, 20k PSI | |
| | in Argon after 1500° C. 2 | |
| | hr sintering) | |
| 20A10B0.05W5P | 20ATZ + 10% BS + 0.05% | 1988 (±217) |
| | AMW + 5% PVP (HIP, 20k PSI | |
| | in Argon after 1500° C. 2 | |
| | hr sintering) | |
| 20A10B0.1W5P | 20ATZ + 10% BS + 0.1% | 1975 (±127) |
| | AMW + 5% PVP (HIP, 20k PSI | |
| | in Argon after 1500° C. 2 | |
| | hr sintering) | |
| 20A10B0.3W5P | 20ATZ + 10% BS + 0.3% | 1931 (±272) |
| | AMW + 5% PVP (HIP, 20k PSI | |
| | in Argon after 1500° C. 2 | |
| | hr sintering) | |
| 20A10B0.5W5P | 20ATZ + 10% BS + 0.5% | 1945 (±338) |
| | AMW + 5% PVP (HIP, 20k PSI | |
| | in Argon after 1500° C. 2 | |
| | hr sintering) | |

NOTE:
All flexural strength specimens were tested after sandblasting under 60 PSI pressure with 50-micron alumina particles after fully sintering.

According to one embodiment, Table 8 shows the change in fracture toughness of 3YSZ and 20ATZ zirconia dental implants according to the presence or absence of FGCL coating of BS (tantalum alkoxide solution) and various sintering conditions after zirconia dental implant binder removal and firing process. Table 8 shows the fracture toughness measurement results of nanoindentation tests were performed with a Berkovich indenter tip using a T1-950 nanomechanical testing system. As shown in Table 8, it can be seen that the fracture toughness values of 3YSZ and 20ATZ zirconia dental implants sintered according to the conventional sintering process and the HIP process do not show a clear difference, respectively. However, after removing the zirconia dental implant binder and sintering, the fracture toughness value was significantly improved depending on the presence or absence of FGCL coating of BS (tantalum alkoxide solution) and the increase in tantalum alkoxide solution concentration.

According to one embodiment, the fracture toughness of the 3YSZ-based zirconia dental implant treated with FGCL is improved by up to 430% compared to the 3YSZ-based zirconia dental implant without FGCL coating. According to another embodiment, the fracture toughness of 20ATZ-based zirconia dental implants treated with FGCL is improved from 106% to 197% compared to 20ATZ-based zirconia dental implants not coated with FGCL.

TABLE 8

| | | Fracture |
|---|---|---|
| | | Toughness |
| Group Name | TEST GROUP | (MPa · m^{1/2}) |
| 3Y | 3YSZ (1580° C. 2.5 hr | 5.0 |
| | Conventional sintering) | |
| 3Y | 3YSZ (HIP, 20k PSI in Argon | 5.5 |
| | after 1500° C. 2 hr sintering) | |
| 3Y15B5P | 3YSZ + 15% BS + 5% PVP | 26.5 |
| | (HIP, 20k PSI in Argon after | |
| | 1500° C. 2 hr sintering) | |
| 20A | 20ATZ (1500° C. 2 hrs, | 6.5 |
| | conventional sintering) | |
| 20A15B5P | 20ATZ + 15% BS + 5% PVP | 19.0 |
| | (1500° C. 2 hrs, | |
| | conventional sintering) | |
| 20A | 20ATZ (HIP, 20k PSI in Argon | 6.4 |
| | after 1500° C. 2 hr sintering) | |
| 20A | 20ATZ (HIP, 30k PSI in Argon | 6.4 |
| | after 1450° C. 2 hr sintering) | |
| 20A10B5P | 20ATZ + 10% BS + 5% PVP | 13.2 |
| | (HIP, 20k PSI in Argon after | |
| | 1500° C. 2 hr sintering) | |
| 20A10B5P | 20ATZ + 10% BS + 5% PVP | 13.5 |
| | (HIP, 30k PSI in Argon after | |
| | 1450° C. 2 hr sintering) | |

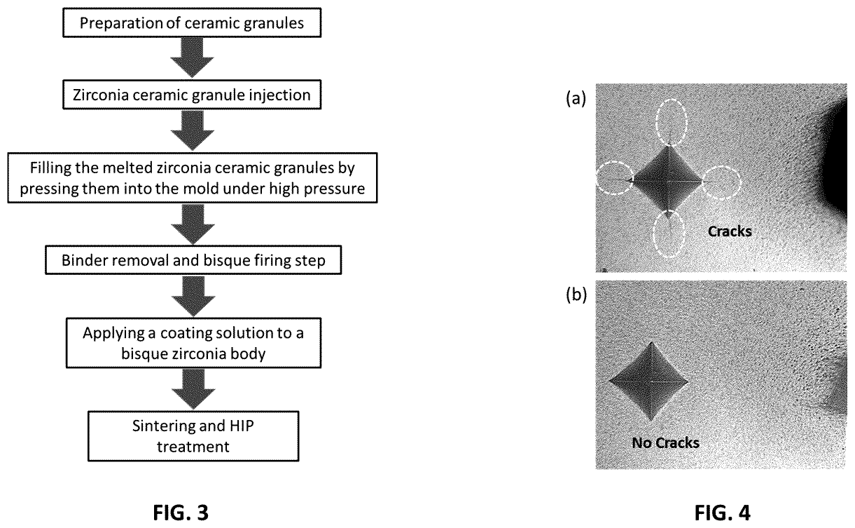

FIG. 3 shows a flow chart of a ceramic injection process for manufacturing a dental implant sintered body according to one embodiment. A process for manufacturing a zirconia dental implant sintered body according to the presently disclosed methods includes injecting a zirconia granule material into a ceramic mold; an injection process of pressing and filling molten zirconia ceramic granules into a mold under high pressure; organic binder removal and firing process of the injected zirconia dental implant molding; FGCL formation, which is step to increase fracture toughness; and sintering and subsequent HIP treatment to increase flexural strength by completely removing defects in the zirconia microstructure.

The zirconia dental implant injection process is a method of injecting granule material for ceramic injection containing a thermoplastic bind into an injection machine and molding it. In certain embodiments, the barrel temperature is preferably in the range of about 120° C. to 220° C., and the temperature of the molding mold is preferably 60° C. to 130° C., the injection pressure is preferably in the range of about 100 bar to 300 bar.

In certain embodiments, the organic binder removal and firing process of the zirconia dental implant injection-molded product includes a step of gradually raising the temperature from room temperature to 970° C., and the time required for the binder removal and firing process is about 25 to 45 hours.

In certain embodiments of the FGCL composition in the present invention, about 5 to 30 wt. % of a single tantalum alkoxide or a single niobium alkoxide may be included. Another embodiment may include a tantalum alkoxide and niobium alkoxide binary mixed solution for the FGCL process. The FGCL solution composed of such a single or binary mixed solution may also include about 0.05 to 5% by weight of antimicrobial metal ions such as Zn, Mo, and W.

In certain embodiments, the FGCL solution composed of the one-component or two-component mixture may contain about 1 to 5% by weight of the PVP organic binder. The FGCL solution composed of the one-component or two-component mixture is characterized in that the degreased porous zirconia implant body is immersed, painted, or spray-coated, followed by primary sintering at a temperature of about 1400° C. or higher.

As an example of the binder removal and firing process of the injection molded body, the injected zirconia dental implant molded body is heated at room temperature to 150° C. for about 1 hour and maintained at the temperature for about 30 to 60 minutes. Then, it is heated from 150° C. to 400° C. for about 25 hours, heated again from 400° C. to 450° C. for about 1 hour, and maintained for about 2-3 hours. And it includes the process of gradually raising the temperature continuously to 970° C., maintaining the temperature for about 1 hour to 3 hours for the bisque process, and then cooling it to room temperature. HIP treatment is performed on a zirconia sintered body at a temperature of about 1450° C. or higher and a high pressure of 10,000 to 30,000 psi to completely remove defects in the microstructure of a zirconia dental implant. As a specific example of the present invention, the FGCL-treated primary sintered zirconia body is HIP-sintered at a temperature of 1450-1600° C. under a pressure of about 137-172 MPa and an Ar gas atmosphere for about 1-5 hours.

The HIP-treated zirconia implant is sandblast-treated with 50-150 micron fused alumina particles, and the pressure used at this time is in the range of 50-100 psi. The sintered body of the HIP-treated zirconia dental implant has high flexural strength (≥1800-2400 MPa) and very high fracture toughness (≥13-26 MPa·m^{1/2}) found in general metal alloys. This method is capable of dramatically improving mechanical properties compared to the values of flexural strength (1000-1200 MPa) and fracture toughness (5-7 MPa·m^{1/2}) of the conventional zirconia sintered body.

FIG. 4 is an image of a 15% BS solution applied to a 10ATZ-based zirconia dental implant bisque body by dip coating, followed by sintering and HIP treatment at 1500° C., and indentation with micro-indent equipment on the cross-sectioned surface. As shown in FIG. 4(b), it was confirmed that the final zirconia dental implant sintered body after FGCL treatment with tantalum alkoxide solution on the porous zirconia dental implant body and sintering and HIP treatment did not cause cracks due to damage to the external surface. This shows that the FGCL treatment can suppress the occurrence of microcracks due to the high fracture toughness properties not found in conventional zirconia dental implants (FIG. 4a). This result can be an indirect scientific basis for greatly extending the fatigue life compared to conventional zirconia dental implants.

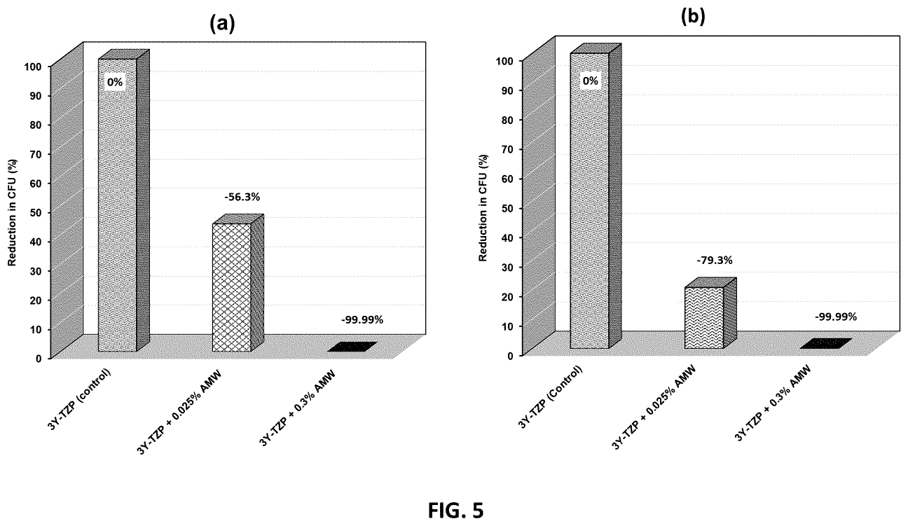

FIGS. 5(a) and 5(b) show the number of colonies forming units (CFU) of bacteria (S. mutans, P. gingivalis) grown on the zirconia ceramic body according to the concentration of the ammonium metatungstic acid (AMW) coating solution after treatment with the tantalum alkoxide coating solution. As a result, the test piece coated with AMW 0.025 wt % showed an antibacterial effect of about 56% (against S. mutans) and about 79% (against P. gingivalis) compared to the control group, and the test piece coated with AMW 0.3 wt % showed an antibacterial effect of about 99.99% (against both S. mutans and P. gingivalis) compared to the control sample.

### Evaluation of Physical Properties of Zirconia Dental Implant Sintered Body

### 3-Point Flexural Strength

Flexure tests were performed on sintered test materials using the Instron-Flexural Strength Following ISO 6872 for preparation of strength testing for dental ceramic, flexural strength bars were milled and prepared. Once prepared, the bars were placed centrally on the bearers of the test machine, so the load applied to a 4 mm wide face was along a line perpendicular to the long axis of the test piece. Then force is applied, and the load needed for breaking the test piece (loading rate was 0.5 mm/min) was recorded. The flexural strength is calculated using sample's dimensional parameter and critical load information.

Flexural strength, ^{δ}, in MPa was calculated according to the following formula:

$$σ = \frac{3 PL}{2 {wb}^{2}}$$

where P is the breaking load, in newton; L is the test span (center-to-center distance between support rollers), in millimeters; w is the width of the specimen, i.e. the dimension of the side at right angles to the direction of the applied load, in millimeters; b is the thickness of the specimen, i.e. the dimension of the side parallel to the direction of the applied load, in millimeters. The mean and standard deviation of the strength was reported. Test bars were prepared by cutting bisque materials taking into consideration the targeted dimensions of the sintered test bars and the enlargement factor (E.F.) of the material, as follows:
starting thickness=3 mm×E.F.;
starting width=4 mm×E.F.;
starting length=35 mm×E.F.

The cut, bisque bars were sintered, and flexural strength data was measured and calculated according to the 3-point flexural strength test described in ISO (International Standard) 6872 Dentistry—Ceramic Materials.

### Fracture Toughness

Nanoindentation tests were performed with a Berkovich indenter tip using a T1-950 nanomechanical testing system (Hysitron). The fracture toughness measurement method by nanoindentation is mainly a specialized method for evaluating the fracture toughness characteristics of coating materials, not bulk materials. Berkovich geometry connects the two edges of the impression and does not allow a halfpenny crack to pass through the center of the indentation. A halfpenny crack may begin as a mid-crack in the firing zone surrounding the indenter tip. However, it is considered more likely to form radial cracks during loading as observed by Cook and Pharr [R. F. Cook and G. M. Pharr, (1990)]. Therefore, the fracture toughness relationship proposed by Laugier [M. T. Laugier, (1987)] can be used to interpret the fracture toughness data with the data generated by the Berkovich indenter in the current study.

For fracture toughness, a force of 3 N or more was applied with the same loading profile as above to induce cracking and 30 measurements were taken for each sample. The fracture toughness (K_{IC}) was calculated using the equation. [Rodney D. Dukino and Michael V Swain (1992) and G. R. Antis, P. Chantikul, B. R. Lawn, and D. R. Marshall, (1981)]:

$${K}_{iC} = 0.015 {( \frac{a}{l} )}^{1 / 2} {( \frac{E}{H} )}^{2 / 3} \frac{P}{{c}^{3 / 2}}$$

where a, l, c, E, H, P indicate the lengths of the imprint (indent), the radial crack, the sum of a and l. Young's modulus, hardness, and indentation load, respectively. In addition, samples were tested after polishing to mirror-like finishes to eliminate any surface effects. The distance between indents were set to greater than 10 times the sum of the lengths of indents and cracks to avoid strain field effects.

Another fracture toughness measurement method is the Vickers micro indentation method, which is mainly relatively simple to measure and is advantageous for obtaining approximate fracture toughness information for localized aspects of a material. The Vickers micro indentation method was used to measure the fracture toughness around the zirconia bulk material surface. Fracture toughness was calculated using the following equivalence principle:

$${K}_{IC} = 0.016 \sqrt{\frac{E}{H}} * \frac{P}{{( {C}_{0} )}^{\frac{3}{2}}}$$

where K_{IC}=Fracture toughness (MPa m^{1/2}); E=Young's Modulus (GPa); H=Hardness (GPa); L=load (N); and C=average crack length (m).

### Evaluation of Antibacterial Properties

### Procedure

Antimicrobial properties of zirconia dental implants were evaluated according to ASTM E2180-07 (2017). The detailed experimental process is as follows.

After three subcultures, an 18-24-hour C. albicans culture was grown in Sabouraud Dextrose (SabDex) broth. The agar slurry was prepared by dissolving 0.85 g NaCl and 0.3 g agar-agar in 100 mL of deionized water and autoclaving at 121±2° C. and 15 psi for 15 minutes. The agar slurry was then equilibrated at 45±2° C. Each sample to be tested (controls and treated samples) were sterilized with 70% isopropanol and placed into sterile 15×100 mm petri dishes. The bacterial broth culture was adjusted to 1−5×108 cfu/mL with a spectrophotometer. Using a sterile cotton swab, sterile biofilm media was spread over the surface of the samples to pre-wet them and aid in even dispersal of the agar slurry, 1.0 mL of standardized culture (1−5×108 cfu/mL) was pipetted into the 100 mL agar slurry, resulting in a final concentration of 1−5×106 cfu/mL. 1.0 mL of the agar slurry was pipetted onto each control and test sample. The agar slurry inoculum was waited to solidify, and the samples were placed in an incubator set to 37±2° C. for 24±2 hours with water added to maintain humidity within the chamber.

Serial dilutions were made after 24±2-hour contact time of both treated and untreated samples, the inoculated agar slurry from the control and treated samples was aseptically transferred into 9.0 mL of DE Neutralizing Broth to form an initial 1:10 dilution of the original inoculum. The samples were vigorously vortexed for one minute. Serial dilutions were made from the recovered slurry and spread onto (SabDex) plates. The plates plated from all the dilution were incubated at 37±2° C. Colony numbers for each dilution plate were counted and recorded.

### Calculation

The geometric mean of the number of organisms recovered from the triplicate incubation period control and incubation period treated samples were determined by the following equation in which X is the number of organisms recovered from the incubation period control or incubations period treated samples:

$$Geometric mean = \frac{( {Log}_{10} {X}_{1} + {Log}_{10} {X}_{2} + {Log}_{10} {X}_{3} )}{3}$$

The percent reduction was calculated using the following formula:

$$\% Reduction = \frac{( a - b ) \times 100}{a}$$

a=the antilog of the geometric mean of organisms recovered from the incubation period control samples
b=the antilog of the geometric mean of the number of organisms recovered from the incubation period treated samples

In view of the many possible embodiments to which the principles of the disclosed invention may be applied, it should be recognized that the illustrated embodiments are only preferred examples of the invention and should not be taken as limiting the scope of the invention.

What is claimed is:

1. A method comprising:
(a) ceramic injection molding a granulated mixture of yttria-stabilized zirconia powder and a thermoplastic organic binder resulting in an injection molded ceramic body;
(b) heat treating the injection molded ceramic body under conditions sufficient for removing the thermoplastic organic binder from the injection molded body;
(c) applying a solution to the injection molded ceramic body, the solution comprising a tantalum-containing material, a niobium-containing material, or a mixture of a tantalum-containing material and a niobium-containing material and penetrating at least a portion of the injection molded ceramic body with the solution;
(d) sintering the injection molded ceramic body; and
(e) hot isostatically pressing the sintered injection molded ceramic body.

2. The method of claim 1, wherein (a) comprises introducing the granulated mixture into an injection molding machine having a barrel heated to 190° C. to 220° C., and a mold heated to 60° C. to 120° C.

3. The method of claim 1, wherein (a) comprises a molding pressure of 120 to 300 bar.

4. The method of claim 1, wherein (b) comprises subjecting the injection molded ceramic body to heating at a temperature of 450° C. to 1000° C. for 100 to 130 hours.

5. The method of claim 1, wherein the solution in (c) comprises 10 wt % to 70 wt % of the tantalum-containing material, 10 wt % to 70 wt % of the niobium-containing material, or 10 wt % to 70 wt % of the mixture of the tantalum-containing material and the niobium-containing material, based on the total weight of the solution.

6. The method of claim 1, wherein the solution in (c) comprises tantalum chloride, tantalum alkoxide, niobium chloride or niobium alkoxide.

7. The method of claim 1, wherein the solution in (c) comprises tantalum (V) chloride anhydrous, tantalum (V) methoxide, tantalum (V) isopropoxide, tantalum (V) ethoxide, or a mixture thereof.

8. The method of claim 1, wherein the solution in (c) comprises 5 wt % to 50 wt % tantalum ethoxide and 1 wt % to 10 wt % polyvinylpyrrolidone (PVP).

9. The method of claim 1, wherein the solution in (c) further comprises at least one antimicrobial metal ion.

10. The method of claim 1, wherein the solution in (c) further comprises a Zn metal ion, a Mo metal ion, or a W metal ion.

11. The method of claim 1, wherein (d) comprises subjecting the injection molded ceramic body to heating at a temperature of 1450° C. to 1500° C. for 1.5 to 3.5 hours.

12. The method of claim 1, wherein (e) comprises heating the sintered injection molded ceramic body under pressure in a pressure transmission gas atmosphere.

13. The method of claim 12, wherein the sintered injection molded ceramic body is subjected to a temperature of 1450° C. to 1600° C.

14. The method of claim 12, wherein the pressure is 137 to 206 MPa.

15. The method of claim 12, wherein the pressure transmission gas is Ar.

16. The method of claim 1, wherein the hot isostatically pressed sintered injection molded ceramic body has a 3-point flexural strength of at least 1800 MPa.

17. The method of claim 1, wherein the hot isostatically pressed sintered injection molded ceramic body has a fracture toughness of at least 13 MPa·m^{1/2}.

18. The method of claim 1, wherein the hot isostatically pressed sintered injection molded ceramic body is in the shape of a dental implant.

19. The method of claim 1, wherein the hot isostatically pressed sintered injection molded ceramic body is in the shape of a restoration crown, and the solution in (c) is applied to a gingival margin region of the crown.
